(19) United States
(12) Patent Application Publication
(10) Pub. No.: US 2024/0383456 A1
(43) Pub. Date: Nov. 21, 2024

(54) BRAKING SYSTEM FOR A RAIL-MOUNTED TRAVELING UNIT OF A TRANSFER VEHICLE

(71) Applicant: DELLNER BUBENZER Germany GmbH, Kirchen-Wehbach (DE)

(72) Inventors: Dirk FAUST, Freudenberg (DE); Sebastian WAESCHENBACH, Freudenberg (DE)

(73) Assignee: DELLNER BUBENZER Germany GmbH, Kirchen-Wehbach (DE)

(21) Appl. No.: 18/787,147

(22) Filed: Jul. 29, 2024

Related U.S. Application Data
(63) Continuation of application No. PCT/EP2023/051837, filed on Jan. 25, 2023.

(30) Foreign Application Priority Data
Jan. 27, 2022 (DE) 20 2022 100 474.9

(51) Int. Cl. B60T 8/172; B60T 8/17; B60T 8/171; B66C 9/14; B66C 19/00

(52) U.S. Cl. CPC B60T 8/172; B60T 8/1705; B60T 8/171; B60T 2210/30; B60T 2250/00; B60T 2250/04; B60T 2270/10; B66C 9/14; B66C 19/002

(57) ABSTRACT

A braking system for a rail-mounted traveling unit of a transfer vehicle. A brake arrangement can be adjusted between a braking position and a venting position and which is designed to exert a settable braking torque in the braking position. A control unit is designed to determine a braking torque and to activate accordingly the brake arrangement. A sensor arrangement detects an operating state of the transfer vehicle and external operating influences and transmits these to the control unit. During operation of the transfer vehicle the sensor arrangement detects the operating state of the transfer vehicle and the external operating influences on the transfer vehicle at periodic intervals and transmits these to the control unit as operating state data and operating influence data. During a braking process, the control unit determines a braking torque to be applied and activates the brake arrangement.

This nonprovisional application is a continuation of International Application No. PCT/EP2023/051837, which was filed on Jan. 25, 2023, and which claims priority to German Patent Application No. 20 2022 100 474.9, which was filed in Germany on Jan. 27, 2022, and which are both herein incorporated by reference.

### BACKGROUND OF THE INVENTION

### Field of the Invention

The present invention relates generally and, in particular, to braking systems for a rail-mounted traveling unit of a transfer vehicle.

### Description of the Background Art

Transfer vehicles which can move on rails are generally known. Such transfer vehicles are used in order to load or to unload freight, such as for example containers, onto or from transport vehicles, such as for example ships, trains or trucks. Such freight can also be transferred between such transport vehicles by a transfer vehicle. Transfer vehicles which carry out such tasks have to be able to decelerate and stop movements in a reliable manner due to their size and their weight.

In typical transfer vehicles, such as container gantry cranes, there is the problem of being able to decelerate and stop the transfer vehicle in a reliable manner. This is because due to the high center of gravity the transfer vehicle must not be permitted to tip over, the supporting frame of the transfer vehicle must not be permitted to be overloaded and is not designed to be distorted under load, and the wheels must not be permitted to be locked on the rails and slide on the rails such that the wheels are flattened on the running surfaces and then run on the rails in an irregular or jerky manner. These incorrect stresses are also intended to be reliably avoided, even under significant wind load and in the event of precipitation and icing up.

Anti-lock braking systems exist in which the braking torque applied to the wheels is set via measurements of the driving dynamics. Such systems have the drawback that with frequent changes to the braking torques applied to the wheels vibrations can occur in the supporting frame of the transfer vehicle, said vibrations for example temporarily relieving the wheels of load, reducing the traction and thus generating undesired slippage of the wheels. In addition, in the case of distances between a central control device and the wheels, an undesirably high deceleration can occur, which impedes a control of such a braking system.

### SUMMARY OF THE INVENTION

It is the object of the present invention to provide a simple braking system for a rail-mounted traveling unit of a transfer vehicle-in particular of container gantry cranes-in which the known drawbacks are reduced as far as possible.

According to a first aspect, the present invention represents a braking system for a rail-mounted traveling unit of a transfer vehicle.

According to a second aspect, the present invention represents a process for operating a braking system.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a transfer vehicle;

FIG. 2 shows an example of a brake arrangement for exerting a braking torque on a wheel of a traveling unit of a transfer vehicle;

FIG. 3 shows an example of a drum brake which can be used as the brake arrangement in FIG. 2;

FIG. 4a shows an example of a disk brake in a rear view which can be used as a brake arrangement in FIG. 2;

FIG. 4b shows an example of a disk brake in a front view which can be used as a brake arrangement in FIG. 2;

FIG. 5a shows an example of a sensor arrangement for measuring a braking state of the transfer vehicle and external operating influences and the transmission to the control unit of FIG. 2;

FIG. 5b shows an example of a sensor arrangement for measuring the load of the traveling units of the transfer vehicle and the transmission to the control unit of FIG. 2; and

FIG. 6 shows an example of a characteristic diagram, a control unit being able to determine thereby the braking torques to be applied.

### DETAILED DESCRIPTION

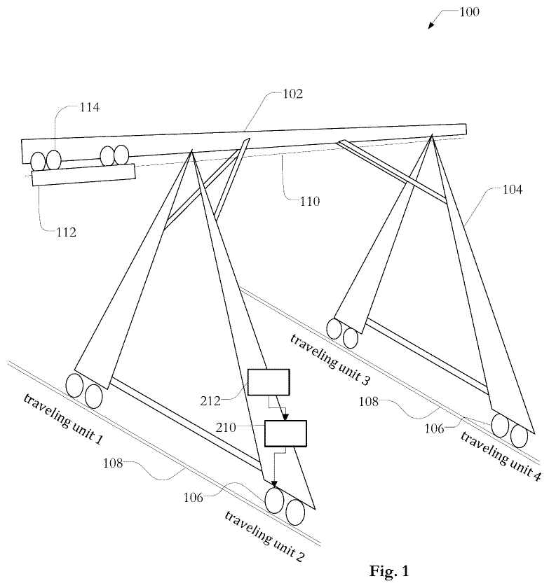

In FIG. 1 an example is illustrated in accordance with the present invention. General explanations of the examples initially precede a detailed description.

According to the examples, the invention relates to a braking system for a rail-mounted traveling unit of a transfer vehicle comprising a brake arrangement which can be adjusted between a braking position and a venting position and which is designed to exert a settable braking torque in the braking position, a control unit which is designed to determine a braking torque and to activate accordingly the brake arrangement, and a sensor arrangement which is designed to detect an operating state of the transfer vehicle as well as external operating influences and to transmit these to the control unit, wherein during operation of the transfer vehicle the sensor arrangement detects the operating state of the transfer vehicle and the external operating influences on the transfer vehicle at periodic intervals and transmits these to the control unit as operating state data and operating influence data, and if a braking process of the transfer vehicle is to be carried out the control unit determines a braking torque to be applied and activates the brake arrangement by means of the transmitted operating state data and operating influence data, and the brake arrangement sets the braking torque so that a sliding of the wheel on the rail and an overload of supporting frame components of the transfer vehicle is avoided.

Operating state data can be data which provides information about the positions, speeds and the direction of travel of the transfer vehicle or individual components of the transfer vehicle. Alternatively, such data provides information about the mass distribution of the transfer vehicle, as well as the weight and the position of freight which are lifted by the transfer vehicle. Thus the position of the center of mass of the transfer vehicle can be determined. Operating state data can also be data which reflects a load on the traveling units or the individual wheels of the traveling units measured directly on the traveling unit components.

The external operating influences can be weather conditions which exert a force on the transfer vehicle, such as for example a wind load. The external operating influences can, however, also be weather conditions which provide information, for example, about precipitation and temperatures which can impair the traction of the wheels of the traveling units on rails.

An overload of the supporting frame components can lead to a twisting or deformation of the supporting frame and a sliding of the wheels can rub the wheels against the rails and thus generate flattened portions on the running surfaces of the wheels.

The brake arrangements can be brakes which generate a braking torque by means of a pretensioning force. The braking torque can be reduced by applying a force which opposes the pretensioning force until the brake arrangement adopts a venting position in which no braking torque is exerted. As a result, these brakes can acquire a safety function, since the full braking torque is exerted (fail-safe principle) in the event of a loss of power in the activation of the brake.

The control unit can determine from the operating state of the transfer vehicle and the external operating influences the braking torques which are to be applied to the various traveling units of the transfer vehicle. This can also influence the traction of the wheels on the rails. It is possible to use threshold values for the forces which can act on the supporting frame components without overloading these components, in order to determine the braking torques.

There are examples in which a brake element (for example a brake disk or a brake drum) of the brake arrangement is mounted on a shaft of a motor which drives the wheel, wherein during a braking process a brake body (for example a brake lining or a brake shoe) in a braking position pushes against the brake element with an application force so that a braking torque acts on the shaft of the motor and thus on the wheel.

There are examples in which the brake arrangement comprises a drum brake.

There are examples in which the brake arrangement comprises a wheel brake.

There are examples in which the brake arrangement comprises a disk brake.

There are examples in which an electrical venting device overcomes the application force by which the brake body pushes against the brake element and the braking torque is generated, in order to reach the venting position.

Electrical venting devices can be, for example, electrical actuating cylinders and actuators. It is important here for the function of the brake that in the event of a loss of power of the venting device no more force is exerted opposing the pretensioning force and the brake closes.

There are examples in which a hydraulic venting device overcomes the application force by which the brake body pushes against the brake element and generates the braking torque, in order to reach the venting position.

Hydraulic venting devices can be, for example, hydraulic cylinders and actuators. It is important here for the function of the brake that in the event of a loss of power of the venting device no more force is exerted opposing the pretensioning force.

There are examples in which an electrohydraulic venting device overcomes the application force by which the brake body pushes against the brake element and generates the braking torque, in order to reach the venting position.

Electrohydraulic venting devices can be, for example, electrically driven pumps which pump a hydraulic fluid from a reservoir into a hydraulic cylinder. The hydraulic cylinder builds up a force which opposes the pretensioning force. It is important here for the function of the brake that in the event of a loss of power of the venting device no more force is exerted opposing the pretensioning force. This occurs due to a failure of the pump and the hydraulic fluid flowing back into the reservoir.

In the event of a complete failure of the power supply of the transfer vehicle, the brake arrangements would accordingly brake with their maximum braking torque. In order to be able to apply the braking torque in a variable manner during a complete failure of the power supply, an uninterruptible power supply (UPS), for example a battery, can be used so that the venting device remains able to be activated.

There are examples in which the operating state data comprises speed data which is specific to the transfer vehicle.

There are examples in which the operating influence data comprises a wind load which acts on the transfer vehicle and which is determined at least from the wind speed and the wind direction.

There are examples in which the control unit determines the braking torque by means of the transmitted operating state data and operating influence data from a characteristic diagram, and in which the braking torque can be set only to 0%, 25%, 50%, 75% or 100% of a maximum braking torque.

There are examples of a process for operating a braking system.

Returning to FIG. 1, this illustrates a first example of a transfer vehicle.

The transfer vehicle 100 is shown as a container gantry crane. A crane bridge 102 is borne by supporting frame components 104. Bridge rails 110, on which a traveling unit with wheels 114 can run, are attached along the crane bridge 102. This traveling unit with wheels 114 is part of a trolley 112 which can be moved suspended below the crane bridge 102 and continually along the crane bridge 102 on the bridge rails 110.

The traveling unit comprises the supporting frame components 104, bears the crane bridge 102 and is also mounted on rails 108 by means of a separate traveling unit with wheels 106, so that the supporting frame can be moved along the rails 108. A control unit 210 and a sensor arrangement 212 are also shown. The control unit 210 receives measurement data from the crane controller or from the sensor arrangement 212 and activates the traveling unit on the basis of these measured values and associated control signals, for example from an operator of the transfer vehicle 100. The control unit 210 can be connected in each case to a traveling unit. A separate control unit for all of the traveling units can be provided here. However, the control unit 210 can also be connected to all of the traveling units and activate these traveling units.

The rails 108 and the bridge rails 110 are oriented at right-angles to one another and thus permit the movement of the trolley 112 in two dimensions. The bridge rails 110 on the crane bridge on which the trolley 112 is directly moved represent a first movement axis of the two dimensions, and the rails 108 on which the entire supporting frame with the crane bridge 102 is moved and accordingly also with the trolley 112 at right-angles to the first movement axis represent a second movement axis of the two dimensions.

A third movement axis is enabled by a hoist. Thus freight can be lifted and lowered in the third movement axis or third dimension. The transfer vehicle 100 can thus load or unload freight onto or from transport vehicles and transfer freight between a plurality of transport vehicles.

During the movements of the trolley 112 along the crane bridge 102 and the supporting frame with the crane bridge 102 along the rails 108, significant masses have to be accelerated and braked. To this end, a torque or braking torque, which is designed either to accelerate or brake the trolley 112 or the supporting frame with the crane bridge 102, is applied to the wheels 106 and 114.

Nevertheless, it can arise, for example in emergency braking situations, that an applied braking torque is sufficiently great to overcome the static friction of the wheels 106 or 114, so that the wheels start to slide on the rails 108 or 110 and rub against the rails.

Moreover, due to the design of the supporting frame and the crane bridge 102 and freight, which represents an additional load on the trolley, a transfer vehicle 100 can have an uneven weight distribution on the traveling units with wheels 106. The center of mass of the transfer vehicle 100 can thus be located closer to some traveling units with wheels 106 than other traveling units with wheels 106.

Starting from the traveling units with wheels 106 a braking torque acts as a lever on the center of mass over its distance from the center of mass. As a result, starting from the traveling units with wheels 106 the braking torque exerts a torque on the center of mass. If the braking torques of all of the traveling units with wheels 106 exert braking torques which are not balanced out, an effective torque acts on the supporting frame of the transfer vehicle 100. Such a torque can overload the supporting frame components 104 so that they are plastically deformed.

In order to prevent this problem, the braking torques which are applied to the traveling units with wheels 106 and 114 can be adapted to braking situations.

The braking torques can also be adapted to a braking situation when the trolley travels. This can occur, for example, in a trolley where the four wheels 114 are directly driven or braked by four motors and four brake arrangements. The trolley can carry freight, for example containers, during its travel. Whether freight is carried and how much the freight weighs changes the weight and the center of gravity of the trolley. These changes have an influence on how the wheels 114 are loaded, both statically and dynamically during a braking process. A center of gravity which is lowered due to the freight, for example, can influence during a braking process the relative ratio of the load on the wheels 114 or the force by which the wheels 114 push onto the rails 110. Moreover, during travel without freight, the weight force on the wheels 114 is lower and a sliding of the wheels 144 on the rails 110 starts even with a smaller applied braking torque than is the case when carrying freight. Accordingly, a weaker braking torque is required when the trolley travels without freight than, for example, during travel in which freight is carried, in order to prevent sliding of the wheels 114. During travel in which freight with a high mass is carried, however, a high braking torque can be required so that the trolley comes to a standstill in a reasonable time.

In order to be able to vary the braking torque, variable torque brakes (“VTB”) have to be used here.

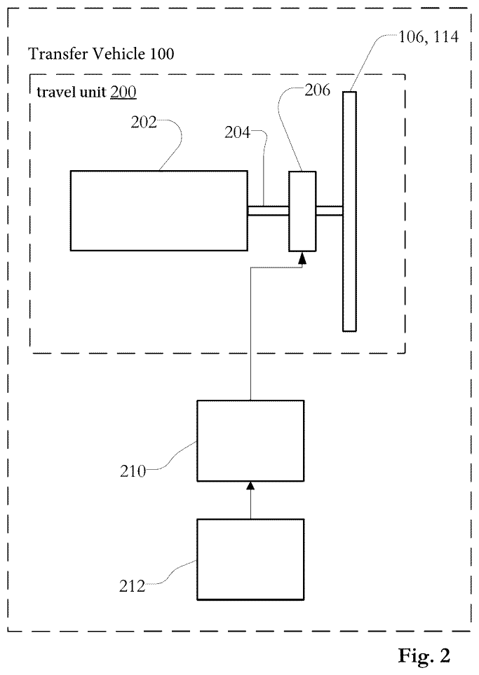

FIG. 2 shows an example of a brake arrangement for exerting a braking torque on a wheel of a traveling unit of the transfer vehicle 100.

A traveling unit 200 with a motor 202 which drives a wheel 106 or 114 via a shaft 204 is shown. The motor 202 is thus used in order to apply a torque to the wheel 106 or 114 and to move the trolley (112 in FIG. 1) or the supporting frame with the crane bridge (102 in FIG. 1).

A brake arrangement 206 is also applied to the same shaft 204. The brake arrangement 206 is used in order to apply a braking torque to the wheel 106 or 114 and to brake the trolley (112 in FIG. 1) or the supporting frame with the crane bridge (102 in FIG. 1).

The brake arrangement 206 is activated by a control unit 210. If a braking process is to be carried out, the control unit 210 determines a braking torque to be applied to the wheel 106 or 114 and activates the brake arrangement 206 such that the braking torque to be applied is applied to the wheel 106 or 114. Measured values of sensors from a sensor arrangement 212 are included in the determination of the braking torque in the control unit 210.

One or more brake arrangements 206 can be directly fitted to the motor 202 and apply a braking torque to the shaft of the motor and thus the wheel 106 or 114. However, one or more brake arrangements 206 can be fitted directly to the wheel 106 or 114 and apply a braking torque thereto. If a combination of motors 202 with wheels 106 or 114 are connected via shafts 204 and possibly also gears, one or more brake arrangements 206 can also be fitted to each of these components in order to apply a braking torque to the wheels 106 or 114.

There are examples, as those in FIG. 2, in which the brake arrangement 206 is directly attached to the wheel 106 or 114. As a result, the brake arrangement 206 can apply a braking torque directly to the wheel 106 or 114. This design is also denoted as a wheel brake.

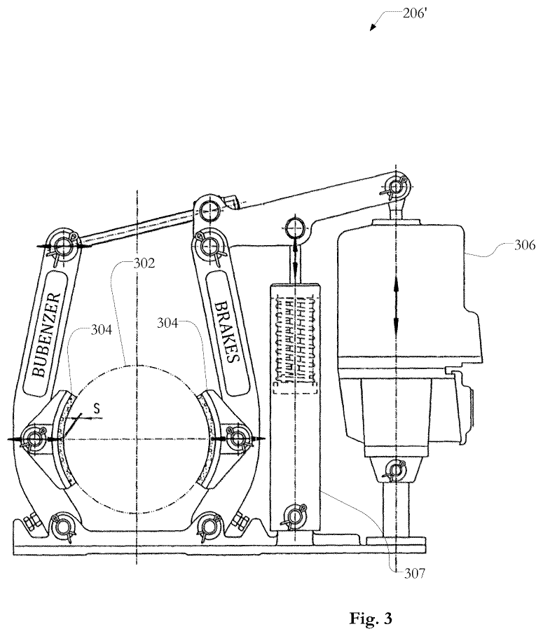

FIG. 3 shows an example of a drum brake which can be used as the brake arrangement in FIG. 2.

The drum brake 206′ consists of a brake element 302 which is connected to a shaft (204 in FIG. 2) and two brake bodies 304 which are fastened via a structure to the supporting frame of the transfer vehicle (100 in FIG. 1) and do not rotate with the shaft. If the brake bodies 304 push with an application force against the circumference of the brake element 302, friction is produced. If the shaft rotates, and thus the brake element 302, the friction generates a torque which opposes the rotation of the shaft and thus brakes these components. Thus the drum brake 206′ can exert a braking torque on the shaft and a wheel (106 or 114 in FIG. 1 and FIG. 2) connected to the shaft.

The drum brake 206′ is designed as a safety brake, whereby in a non-energized state it adopts a braking position in which a pretensioning force pushes the brake bodies 304 against the circumference of the brake element 302. The pretensioning force is applied by a pretensioning element 307. A venting device 306, for example an electrohydraulic venting device, applies a force which opposes the pretensioning force, releases the braking bodies 304 from the circumference of the brake element 302 and thus brings the drum brake 206′ into a venting position. In the venting position no braking torque is exerted.

The venting device 306 is activated by a control unit (210 in FIG. 2) and can vary the applied force opposing the pretensioning force. The venting device 306 can thus be activated in order to bring the drum brake 206′ into a venting position. In addition, the venting device 306 can apply a force which opposes the pretensioning force but is weaker than the pretensioning force, resulting in the application force by which the brake bodies 304 push against the circumference of the brake element 302.

The application force can be varied by the control unit, from no force up to the pretensioning force. The braking torque of the drum brake 206′ can accordingly be varied by the control unit, from no braking torque in the venting position up to the maximum braking torque due to the pretensioning force.

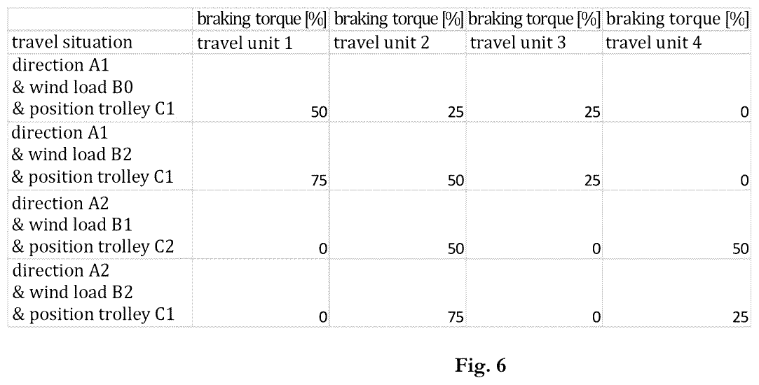

In the event of a complete failure of the power supply of the transfer vehicle, the brake arrangements would accordingly brake with their maximum braking torque. In order to be able to apply the braking torque in a variable manner during a complete failure of the power supply, an uninterruptible power supply (UPS), for example a battery, can be used so that the venting device remains able to be activated. It is possible to access load data, as in FIG. 6, which is the latest load data which was stored before the complete failure of the power supply, for example in the control device (210 in FIG. 1).

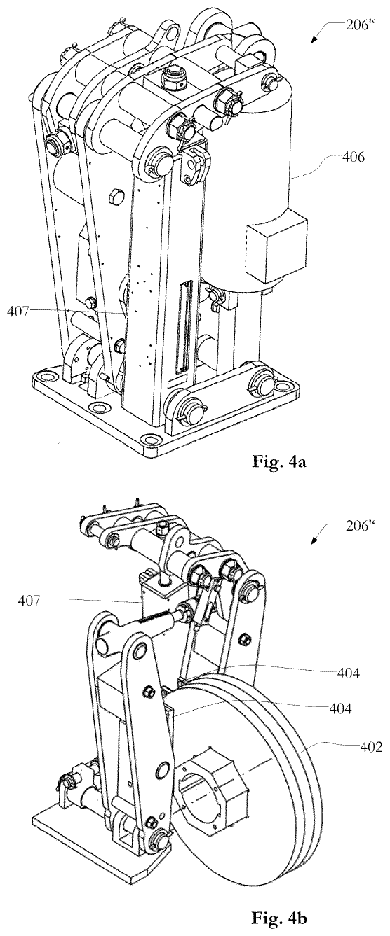

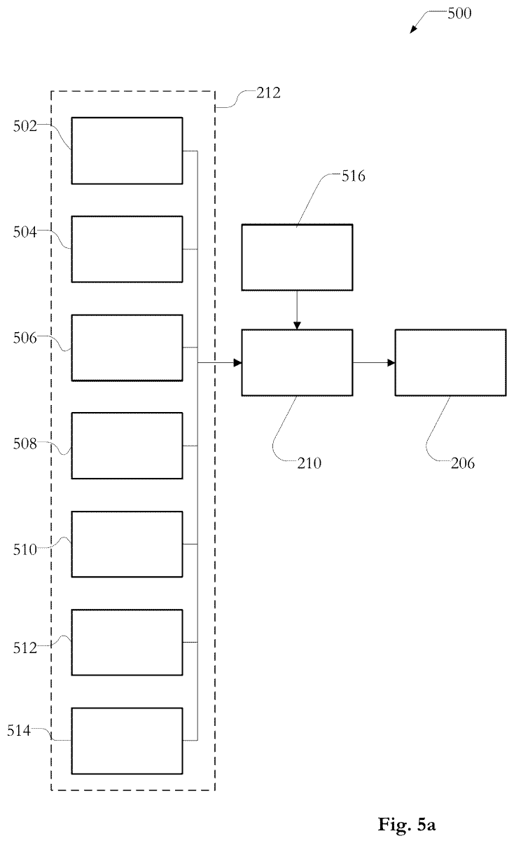

FIG. 4a shows an example of a disk brake in a rear view which can be used as the brake arrangement in FIG. 2, and FIG. 4b shows an example of a disk brake in a front view which can be used as the brake arrangement in FIG. 2.

A pretensioning element 407 which brings the disk brake 206″ into a braking position by exerting a pretensioning force is shown in the rear view of FIG. 4a. The venting device 406 builds up a force which opposes the pretensioning force of the pretensioning element 407 and brings the disk brake into a venting position.

The venting device 406 is activated by a control unit (210 in FIG. 2) and can vary the applied force opposing the pretensioning force. The venting device 406 can thus be activated in order to bring the disk brake 206″ into a venting position. In addition, the venting device 406 can apply a force which opposes the pretensioning force but is weaker than the pretensioning force, resulting in a total application force by which the brake bodies (404 in FIG. 4b) push against the side surfaces of the brake element (402 in FIG. 4b). In the venting position no braking torque is exerted.

As shown in FIG. 4b, the disk brake 206″ consists of a brake element 402 which is connected to a shaft (204 in FIG. 2) and two brake bodies 404 which are fastened via a structure to the supporting frame of the transfer vehicle (100 in FIG. 1) and do not rotate with the shaft. If the brake bodies 404 push with an application force against the side surfaces (bottom surface and top surface in a cylinder) of the brake element 302, friction is produced. If the shaft rotates and thus the brake element 302, the friction generates a torque which opposes the rotation of the shaft and thus brakes these components. Thus the disk brake 206″ can exert a braking torque on the shaft and a wheel (106 or 114 in FIG. 1 and FIG. 2) connected to the shaft.

The disk brake 206″ is designed as a safety brake, whereby in a non-energized state it adopts a braking position in which the pretensioning force pushes the brake bodies 404 against the side surfaces of the brake element 402. A venting device (406 in FIG. 4a) applies a force which opposes the pretensioning force, releases the brake bodies 304 from the side surfaces of the brake element 402 and thus brings the disk brake 206″ into a venting position. In the venting position no braking torque is exerted.

The application force can be varied by the control unit, from no force up to the pretensioning force. The braking torque of the disk brake 206″ can accordingly be varied by the control unit, from no braking torque in the venting position up to the maximum braking torque due to the pretensioning force.

Both the disk brake 206″ and the drum brake (206′ in FIG. 3) use a venting device (306 in FIG. 3 and 406 in FIG. 4a).

There are examples in which the venting device electrically generates the force and also a stroke, which oppose the pretensioning force and release the brake bodies 404 (304 in FIG. 3) from the brake element 402 (302 in FIG. 3), for example by a linear motor or an electrical actuator or electrical actuating cylinder.

There are examples in which the venting device hydraulically generates the force and also a stroke, which oppose the pretensioning force and release the brake bodies 404 (304 in FIG. 3) from the brake element 402 (302 in FIG. 3), for example by a hydraulic cylinder or a hydraulic actuator. Hydraulic cylinders or actuators can set the exerted force by means of a proportional valve and thus apply the variable force which opposes the pretensioning force.

There are further examples in which the venting device electrohydraulically generates the force and also a stroke, which oppose the pretensioning force and release the brake bodies 404 (304 in FIG. 3) from the brake element 402 (302 in FIG. 3), for example by an electrohydraulic cylinder or an electrohydraulic actuator. Electrohydraulic cylinders or actuators can set the exerted force by means of a proportional valve and thus apply the variable force which opposes the pretensioning force.

In the event of a complete failure of the power supply of the transfer vehicle, the brake arrangements would accordingly brake with their maximum braking torque. In order to be able to apply the braking torque in a variable manner during a complete failure of the power supply, an uninterruptible power supply (UPS), for example a battery, can be used so that the venting device remains able to be activated. It is possible to access load data, as in FIG. 6, which is the latest load data which was stored before the complete failure of the power supply, for example in the control device (210 in FIG. 1).

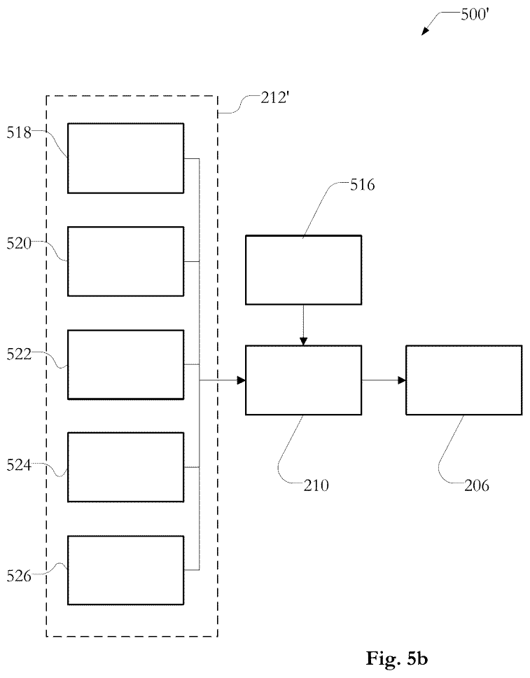

FIG. 5a shows an example of a sensor arrangement for measuring an operating state of the transfer vehicle and external operating influences and the transmission to the control unit of FIG. 2.

The control unit 210 obtains and evaluates data from sensors 502 to 510 which form a sensor arrangement 212 and activates the brake arrangement 206 on the basis of this data which has been obtained and evaluated, when a braking process is to be initiated. A braking process can be initiated in normal operation of the crane, but the braking process can also be triggered by the actuation of an emergency brake 516.

A sensor 502 can measure, for example, the position of the trolley (112 in FIG. 1) along the crane bridge (102 in FIG. 1) and transmit this to the control unit 210. From this position the control unit 210 can then determine the position of the center of mass of the transfer vehicle (100 in FIG. 1). The load results from the determined center of mass, on the basis of the weight distribution of the four traveling units with wheels 106 in the four corners of the supporting frame of the transfer vehicle.

A sensor 504 can measure the speed of the trolley (112 in FIG. 1) and transmit this to the control unit 201. The control unit 210 can also determine the speed of the trolley from the change in position of the trolley. A sensor 506 can measure the position of the transfer vehicle (100 in FIG. 1) along the rails (108 in FIG. 1) and a further sensor 508 can measure the speed.

A further sensor 510 can measure the wind speed, while a sensor 512 measures the wind direction. Both sensors 510 and 512 transmit the measured values to the control unit 210 and the control unit 210 determines from the measured values the wind load which acts on the transfer vehicle (100 in FIG. 1). In particular, it is also possible to determine the wind load on the trolley and possible freight connected to the trolley. From the wind load the control unit can then determine a change of load, on the basis of the center of mass on the four individual traveling units with wheels 106 on the four corners of the supporting frame.

From the speed of the trolley and the wind load which acts on the trolley, the control unit 210 can determine the braking torque at which the wheels (114 in FIG. 1) of the trolley have to be braked in order to stop the trolley as quickly as possible without the wheels starting to slide on the rails (110 in FIG. 1).

From the loads which have been determined for the four individual traveling units with wheels 106 on the four corners of the supporting frame, the control unit 210 can determine a braking torque for each traveling unit in the four corners of the supporting frame in order to stop the transfer vehicle as quickly as possible without the wheels (106 in FIG. 1) starting to slip on the rails (108 in FIG. 1) and without the load of the supporting frame being too great, so that the supporting frame is not distorted, twisted or the transfer vehicle tips over.

A sensor 514 can monitor specific system components of the transfer vehicle and trigger an emergency stop of the transfer vehicle in the event of a failure of these system components.

There are examples in which further sensors detect weather conditions which influence the traction of the wheels on the rails.

It can be ascertained at any time which braking torques ideally have to be applied, by periodically obtaining measured values of the sensors and determining the braking torques to be applied. These braking torques can be stored such that they can be read in the event of a system failure of the transfer vehicle or an emergency stop and the brake arrangements (206 in FIG. 2) can be activated so that these braking torques are applied.

FIG. 5b shows an example of a sensor arrangement for measuring the load of the traveling units of the transfer vehicle and the transmission to the control unit of FIG. 2.

The transmission to the control unit is carried out as shown in FIG. 5a. This sensor arrangement 212′ comprises four force measuring sensors 518 to 524 which determine the load on each traveling unit of the four traveling units of the transfer vehicle (100 in FIG. 1). The force measuring sensors can be designed, for example, as strain gauges. As a result, it is possible to measure an elongation of a traveling unit component, this elongation being dependent on the load or force applied to the traveling unit.

A force measuring sensor thus permits the measurement of a current support load or load on the traveling unit and the setting of a corresponding braking torque.

The control unit 210 obtains and evaluates data from sensors 518 to 526 which form a sensor arrangement 212 and activates the brake arrangement 206 on the basis of this data which has been obtained and evaluated when a braking process is to be initiated. A braking process can be initiated in normal operation of the crane, but the braking process can also be triggered by the actuation of an emergency stop 516. A sensor 526 can monitor specific system components of the transfer vehicle and also trigger an emergency stop of the transfer vehicle in the event of a failure of these system components.

FIG. 6 shows an example of a characteristic diagram, a control unit being able to determine thereby the braking torques to be applied.

A section of the characteristic diagram is shown as a table, which shows travel situations and the braking torques to be applied. The braking torques are limited here to the four traveling units (traveling units 1 to 4, also in FIG. 1) with the wheels (106 in FIG. 1) in the four corners of the supporting frame of the transfer vehicle (100 in FIG. 1). A determination of the braking torques for the wheels (114 in FIG. 1) of the trolley (112 in FIG. 1) can be carried out in a similar manner.

The traveling units 1 and 2 are the rear traveling units of FIG. 1, while the traveling units 3 and 4 are the front traveling units which are located below the overhang of the crane bridge (102 in FIG. 1).

For determining the respective travel situation, the detected measured values of the sensors as shown in FIG. 5 are used. It is determined whether the measured values are within specific ranges. The ranges A1 and A2 are categorized for the direction of movement of the transfer vehicle (100 in FIG. 1), and a movement of the transfer vehicle to the side of the traveling units 1 and 3 can be classified as category A1 and a movement to the side of the traveling units 2 and 4 can be classified as category A2.

Moreover, the wind load can also be classified in specific categories on the basis of its strength and direction, for example B0, B1 and B2. Here, for example, an assignment to the category B0 can be made when the wind falls below a specific threshold value. A category B1 can be assigned when the wind exceeds the threshold value and blows from the direction at the side of the traveling units 1 and 2. A category B2 can be assigned when the wind exceeds the threshold value and blows from the direction at the side of the traveling units 3 and 4.

The same applies to the position of the trolley, for example when the trolley is positioned in the overhang of the crane bridge the position of the trolley can be categorized as C2 and when the trolley is located between the traveling units with wheels (106 in FIG. 1) the position of the trolley can be categorized as C1.

In the first line of the characteristic diagram a travel situation is determined, with a direction of movement of the transfer vehicle in the direction A1, a wind load below the threshold value, i.e. category B0, and a position of the trolley in the overhang of the crane bridge, i.e. category C1. Due to the direction of movement of the transfer vehicle, during a braking process the load applied to the traveling units 1 and 3 is greater than to the traveling units 2 and 4. As a result, as a while more powerful braking can be applied to the traveling units 1 and 3 than to the traveling units 2 and 4. The wind has no influence on the braking torques. Due to the position of the trolley in the overhang of the crane bridge, more powerful braking can be applied to the traveling units 1 and 2 as a whole than to the traveling units 3 and 4. This results in a braking torque of 50% of the pretensioning force on the traveling unit 1 and 25% of the pretensioning force on the traveling units 2 and 3. No braking torque is applied to the traveling unit 4.

In the second line of the characteristic diagram a travel situation is determined, with a direction of movement of the transfer vehicle in the direction A1, a wind speed above the threshold value, which blows from the direction at the side of the traveling units 3 and 4, i.e. category B2, and a position of the trolley in the overhang of the crane bridge, i.e. category C1. Due to the direction of movement of the transfer vehicle, during a braking process the load applied to the traveling units 1 and 3 is greater than to the traveling units 2 and 4. As a result, more powerful braking can be applied to the traveling units 1 and 3 as a whole than to the traveling units 2 and 4. The wind load applies greater load to the traveling units 1 and 2 as a whole, while the traveling units 3 and 4 are relieved of load. The position of the trolley in the overhang of the crane bridge applies greater load to the traveling units 1 and 2 as a whole and relieves the traveling units 3 and 4 of load. This results in a braking torque of 75% of the pretensioning force on the traveling unit 1, 50% of the pretensioning force on the traveling unit 2 and 25% of the pretensioning force on the traveling unit 3. No braking torque is applied to the traveling unit 4.

In the third line of the characteristic diagram a travel situation is determined, with a direction of movement of the transfer vehicle in the direction A2, a wind speed above the threshold value which blows from the direction at the side of the traveling units 1 and 2, i.e. category B1, and a position of the trolley between the traveling units 1 to 4, i.e. category C2. Due to the direction of movement of the transfer vehicle, during a braking process the load applied to the traveling units 2 and 4 is greater than to the traveling units 1 and 3. As a result, more powerful braking can be applied to the traveling units 2 and 4 as a whole than to the traveling units 1 and 3. Due to the position of the trolley between the traveling units 1 to 4, all of the traveling units are approximately equally loaded thereby. The wind which blows from the direction at the side of the traveling units 3 and 4 relieves the traveling units 1 and 2 of load as a whole, while the traveling units 3 and 4 are loaded. As a result, only the traveling units 2 and 4 are uniformly braked with 50% of the pretensioning force as the application force. No braking torque is applied to the remaining traveling units. The wind load compensates, for example, for different loads of the traveling units which can be caused by a one-sided overhang of the crane bridge.

In the fourth line of the characteristic diagram a travel situation is determined, with a direction of movement of the transfer vehicle in the direction A2, a wind speed above the threshold value which blows from the direction at the side of the traveling units 3 and 4, i.e. category B2, and a position of the trolley between the traveling units 1 to 4, i.e. category C2. Due to the direction of movement of the transfer vehicle, during a braking process the load applied to the traveling units 2 and 4 is greater than to the traveling units 1 and 3. As a result, more powerful braking can be applied to the traveling units 2 and 4 as a whole than to the traveling units 1 and 3. The wind load applies greater load to the traveling units 1 and 2 as a whole, while the traveling units 3 and 4 are relieved of load. Due to the position of the trolley between the traveling units 1 to 4, they are approximately equally loaded by the trolley. As a result, the traveling unit 2 is braked with a braking torque of 75% of the pretensioning force as the application force and the traveling unit 4 is braked with 25% of the pretensioning force. No braking torque is applied to the remaining traveling units.

The listed travel situations and categories for the measured values of the sensors are not a definitive list. For example, wind directions which blow from the side of the traveling units 2 and 3 or the traveling units 1 and 4 can also be categorized as wind loads. It is possible to categorize winds which can act, for example, diagonally to the directions of movement. Generally the speeds, for example of the trolley of the transfer vehicle or the wind, can be more finely categorized by being compared, for example, with an increasing series of threshold values.

As can be shown in FIG. 5b, the loads on the traveling units 1 to 4 can also be determined by direct measurement by force measuring sensors which are attached to the traveling units. Such force measuring sensors can be implemented, for example, by strain gauges. Operating states and external operating influences of the transfer vehicle can be already included in the determined loads of the traveling units. On the basis of models, a maximum applicable braking torque can be determined from these loads so that a sliding of the wheels 106 or 114 on the rails 108 and 110 is avoided, but the transfer vehicle or the trolley come to a standstill as quickly as possible. Moreover, weather data which provides information, for example, about the traction of the wheels 106 or 114 on the rails 108 and 110 can be detected and included in the models.

In the event of a complete failure of the power supply of the transfer vehicle, the brake arrangements would brake with their maximum braking torque. In order to be able to apply the braking torque in a variable manner during a complete failure of the power supply, an uninterruptible power supply (UPS), for example a battery, can be used so that the venting device remains able to be activated. It is possible to access load data, as in FIG. 6, which is the latest load data which was stored before the complete failure of the power supply, for example in the control device (210 in FIG. 1).

A combination of the examples is provided. Thus, for example, brake arrangements can be used at different points of the transfer vehicle, wherein a proportion of the brake arrangements are designed as drum brakes and a further proportion are designed as disk brakes. This can also be implemented within the same traveling unit, for example by a disk brake which is attached to the wheels of the traveling unit and a drum brake which is attached to the shaft of the motor. The number of sensors for measuring the operating state of the transfer vehicle and external operating influences can also comprise further sensors which detect, for example, weather data or a weight of freight located on the trolley.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A braking system for a rail-mounted traveling unit of a transfer vehicle, the braking system comprising:
a brake arrangement adapted to be adjusted between a braking position and a venting position and which is designed to exert a settable braking torque in the braking position;
a control unit to determine a braking torque and to activate accordingly the brake arrangement; and
a sensor arrangement to detect an operating state of the transfer vehicle as well as external operating influences and to transmit these to the control unit, wherein during operation of the transfer vehicle, the sensor arrangement detects an operating state of the transfer vehicle and external operating influences on the transfer vehicle at periodic intervals and transmits these to the control unit as operating state data and operating influence data, and if a braking process of the transfer vehicle is to be carried out the control unit determines a braking torque to be applied and activates the brake arrangement via the transmitted operating state data and operating influence data, and the brake arrangement sets the braking torque so that a sliding of the wheel on the rail and an overload of supporting frame components of the transfer vehicle is avoided.

2. The braking system as claimed in claim 1, wherein a brake element of the brake arrangement is mounted on a shaft of a motor which drives the wheel, wherein during a braking process a brake body in a braking position pushes against the brake element with an application force so that a braking torque acts on the shaft of the motor and the wheel.

3. The braking system as claimed in claim 2, wherein the brake arrangement comprises a drum brake.

4. The braking system as claimed in claim 2, wherein the brake arrangement comprises a disk brake.

5. The braking system as claimed in claim 2, wherein an electrical venting device overcomes the application force by which the brake body pushes against the brake element and generates the braking torque, in order to reach the venting position.

6. The braking system as claimed in claim 2, wherein a hydraulic venting device overcomes the application force by which the brake body pushes against the brake element and generates the braking torque, in order to reach the venting position.

7. The braking system as claimed in claim 1, wherein the operating state data comprises speed data which is specific to the transfer vehicle.

8. The braking system as claimed in claim 1, wherein the operating influence data comprises a wind load which acts on the transfer vehicle and which is determined at least from the wind speed and the wind direction.

9. The braking system as claimed in claim 1, wherein the control unit determines the braking torque via the transmitted operating state data and operating influence data from a characteristic diagram and wherein the braking torque is set only to 0%, 25%, 50%, 75% or 100% of a maximum braking torque.

10. A process for operating a braking system as claimed in claim 1.
